(19) United States
(12) Patent Application Publication
(10) Pub. No.: US 2026/0296024 A1
(43) Pub. Date: Oct. 1, 2026

(54) AUTOMATICALLY MOUNTING PRINTHEAD PROTECTION DEVICE FOR PROTECTING AT LEAST ONE PRINTHEAD

(71) Applicants: Airbus SAS, BLAGNAC (FR); Airbus Operations SAS, TOULOUSE (FR); Airbus Operations GmbH, HAMBURG (DE)

(72) Inventors: Matthias OTTO, HAMBURG (DE); Fabian MAHLER, HAMBURG (DE); Boris MORINIERE, ROCHEFORT (FR); Olivier BURGY, TOULOUSE (FR); Samuel LELEU, TOULOUSE (FR)

(21) Appl. No.: 19/572,089

(22) Filed: Mar. 19, 2026

(30) Foreign Application Priority Data
Mar. 28, 2025 (EP) 25167187.1

(51) Int. Cl. B41J 2/165; B41J 29/02

(52) U.S. Cl. CPC B41J 2/16511; B41J 29/02; B41J 2202/15

(57) ABSTRACT

A protection device with: at least one head protection cover configured to cover at least one printhead of a printing device, at least one frame, at least one flexible connection system connecting the head protection cover and the frame, at least one automatic fastening system configured to connect the frame and the printing device. Also a printing equipment including at least one such protection device.

### CROSS-REFERENCES TO RELATED APPLICATIONS

This application claims the benefit of European Patent Application Number 25167187.1, filed on Mar. 28, 2025, the entire disclosure of which is incorporated herein by way of reference.

### FIELD OF THE INVENTION

The present application relates to an automatically mounting printhead protection device for protecting at least one printhead.

### BACKGROUND OF THE INVENTION

According to a known embodiment, a printing equipment comprises a plurality of juxtaposed printheads and a robotic arm at the end of which the printheads are positioned, said robotic arm being configured to move said printheads relative to a surface to be printed. Each printhead comprises a plurality of nozzles and a peripheral contact surface surrounding the nozzles. The peripheral contact surfaces of the different printheads are substantially coplanar.

In order to keep the printheads in good working order, a protective cover is attached to each printhead when not in use in order to protect the nozzles.

According to one embodiment, each protective cover has a peripheral edge configured to be pressed against the peripheral contact surface of a printhead. Screws are generally used to keep the protective cover in place.

According to one operating mode, the operations of fitting the protective covers and of screwing the screws in order to keep said covers in place are manual operations. This solution is not satisfactory because it requires the intervention of a person.

The present invention seeks to overcome all or some of the drawbacks of the prior art.

### SUMMARY OF THE INVENTION

To this end, the invention relates to a protection device comprising at least one head protection cover configured to cover at least one printhead of a printing device.

According to the invention, the protection device comprises:
at least one frame comprising at least one rigid plate which has a first face oriented towards the printing device during operation, a second face opposite the first face, and at least one first opening, passing through the rigid plate, configured to house said at least one head protection cover,
for each head protection cover, at least one flexible connection system comprising first and second elastically deformable and diametrically opposing blades which connect the head protection cover and the rigid plate, and
at least one automatic fastening system configured to connect the rigid plate and the printing device.

This protection device allows automatic mounting of each protective cover on the corresponding printhead, without operator intervention.

According to another feature, the fastening system is connected to the rigid plate by a flexible and deformable connection allowing a slight deflection of the fastening system with respect to the rigid plate.

The invention also relates to an item of printing equipment comprising at least one protection device according to one of the preceding features.

According to another feature, the printing equipment comprises a receptacle which has a housing suitable for at least partially housing the protection device.

According to another feature, at least one element from among the frame and the receptacle comprises at least one poka-yoke allowing the frame to be positioned in the receptacle in an unique position.

According to another feature, each fastening system comprises a first part secured to the printing device and a second part secured to the rigid plate, the first and second parts being configured to occupy a coupled state in which the first and second parts are secured to one another and an uncoupled state in which the first and second parts are detached from one another.

According to another feature, the first and second parts comprise male and female parts configured to allow self-centering of the first part with respect to the second part.

According to another feature, each fastening system comprises:
at least one locking and unlocking system configured to occupy a locked state, in which the locking and unlocking system keeps the male part in the female part, and an unlocked state, in which the locking and unlocking system allows the male part to enter or exit the female part,
at least one controller configured to control the locked/unlocked state of the locking and unlocking system of each fastening system.

### BRIEF DESCRIPTION OF THE DRAWINGS

Other features and advantages are set out in the description of the invention below, given purely by way of example and with reference to the attached drawings, in which:

FIG. 1 is a perspective view of an item of printing equipment comprising at least one protection device illustrating one embodiment of the invention;

FIG. 2 is a schematic representation of a fastening system illustrating one embodiment of the invention;

FIG. 3 is a perspective view of a protection device illustrating one embodiment of the invention; and,

FIG. 4 is a perspective view of the protection device, visible in FIG. 3, positioned in a receptacle, illustrating one embodiment of the invention.

### DETAILED DESCRIPTION OF THE PREFERRED EMBODIMENTS

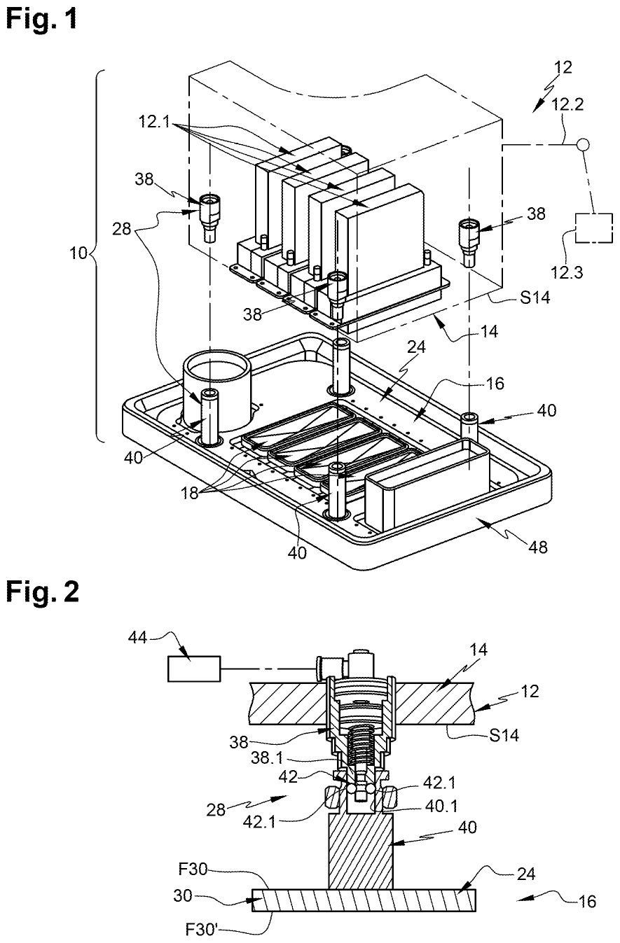

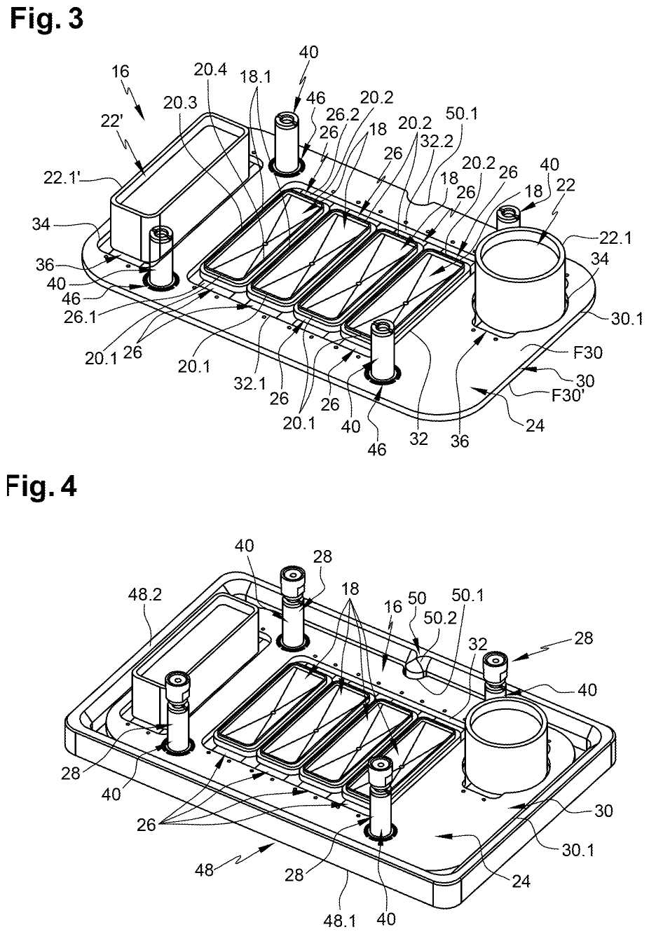

According to one embodiment visible in FIG. 1, an item of printing equipment 10 comprises a printing device 12 including a plurality of juxtaposed printheads 12.1 and a robotic arm 12.2 (shown schematically) which has a first end connected to a fixed base 12.3 and a second end, movable relative to the first end, to which the printheads 12.1 are connected. Each printhead 12.1 comprises a plurality of nozzles and a peripheral contact surface surrounding the nozzles. The peripheral contact surfaces of the different printheads are substantially coplanar. The printheads 12.1 are not described further because they can be identical to those of the prior art.

Whatever the embodiment, the printing device 12 comprises at least one printhead 12.1 and a fastening structure 14 to which each printhead 12.1 is connected.

According to one arrangement, the fastening structure 14 has a fastening face S14 surrounding the printheads 12.1, substantially parallel to the peripheral contact surfaces of the printheads 12.1.

The printing equipment 10 comprises at least one protection device 16 which includes at least one head protection cover 18 configured to cover at least one printhead 12.1.

According to one embodiment, the protection device 16 comprises a plurality of head protection covers 18, one for each printhead 12.1. The different head protection covers 18 are juxtaposed and independent of one another.

According to one embodiment, each head protection cover 18 has a first peripheral edge 18.1 configured to be pressed against the peripheral contact surface of a printhead 12.1. According to one configuration, the first peripheral edge 18.1 describes a rectangle with rounded corners. The first peripheral edge 18.1 of each head protection cover 18 comprises first and second short sides 20.1, 20.2 and third and fourth long sides 20.3, 20.4, the first sides 20.1 of the different head protection covers 18 being aligned, the second short sides 20.2 of the different head protection covers 18 being aligned, and the third and fourth long sides 20.3, 20.4 of the different head protection covers 18 being adjoining in pairs.

According to one embodiment, each head protection cover 18 is configured to absorb any residual ink present at the nozzles at the end of printing in order to keep the nozzles clean when they are not in use.

According to one configuration, the protection device 16 comprises at least one sensor protection cover 22 configured to protect a lens of a camera, for example. Each sensor protection cover 22 comprises a peripheral edge 22.1 configured to be pressed against a contact surface of a sensor. According to one arrangement, the protection device comprises first and second sensor protection covers 22, 22′ positioned on either side of the head protection covers 18, the first sensor protection cover 22 having a circular peripheral edge 22.1 and the second sensor protection cover 22′ having a rectangular peripheral edge 22.1′ with rounded corners.

The protection device 16 comprises at least one frame 24, at least one flexible connection system 26 connecting the head protection cover 18 and the frame 24 and at least one automatic fastening system 28 configured to connect the frame 24 and a printing device 12, more particularly the frame 24 and a fastening structure 14 for a printing device 12.

According to one embodiment, the frame 24 comprises at least one rigid plate 30 which has a first face F30 oriented towards the printing device 12 during operation, a second face F30′ opposite the first face F30, at least one first peripheral edge 30.1 and at least one first opening 32, passing through the rigid plate 30 and opening onto the first and second faces F30, F30′, configured to house at least one head protection cover 18. According to one arrangement, the rigid plate 30 comprises a first opening 32 configured to house all of the head protection covers 18. This first opening 32 is rectangular and has first and second long sides 32.1, 32.2 between which the different head protection covers 18 are positioned.

According to one embodiment, the rigid plate 30 is made of metal or of composite material. By way of example, the rigid plate 30 is made of aluminum alloy.

According to one embodiment, for each head protection cover 18, the flexible connection system 26 is configured to allow a slight deflection of the head protection cover 18 with respect to the frame 24. It comprises first and second elastically deformable and diametrically opposing blades 26.1, 26.2 which connect the head protection cover 18 and the rigid plate 30. According to one arrangement, the first and second blades 26.1, 26.2 respectively connect the first and second short sides 20.1, 20.2 of the head protection cover 18 and the rigid plate 30. These first and second blades 26.1, 26.2 can deform elastically and enable a movement of the head protection cover 18 in a direction substantially perpendicular to the first face F30 of the rigid plate 30.

When a sensor protection cover 22 is present, the rigid plate 30 comprises a second opening 34 configured to house the sensor protection cover 22, the latter being connected to the rigid plate 30 by a connection system 36 such as diametrically opposing first and second blades 26.1, 26.2, for example.

According to one arrangement, the protection device 16 comprises a plurality of fastening systems 28 positioned around the head protection covers 18, in particular around the first opening 32 of the rigid plate 30. In the case of a rectangular first opening 32, the protection device 16 comprises four fastening systems 28 situated approximately at the corners of the first opening 32. Naturally, the invention is not limited to this number of fastening systems 28. More generally, the protection device 16 comprises at least one fastening system 28.

According to one embodiment, each fastening system 28 comprises a first part 38 secured to the printing device 12 and a second part 40 secured to the frame 24, the first and second parts 38, 40 being configured to cooperate with one another and to occupy a coupled state in which the first and second parts 38, 40 are secured to one another and an uncoupled state in which the first and second parts 38, 40 are detached from one another.

According to a configuration visible in FIG. 2, the first and second parts 38, 40 respectively comprise a male part 38.1, such as a cylinder, for example, and a female part 40.1 configured to house the male part 38.1 as a close fit. The male and female parts 38.1, 40.1 are configured to allow self-centering of the first part 38 with respect to the second part 40.

Each fastening system 28 comprises at least one locking and unlocking system 42 configured to occupy a locked state, in which the locking and unlocking system 42 keeps the male part 38.1 in the female part 40.1 and prevents the withdrawal thereof, and an unlocked state, in which the locking and unlocking system 42 allows the male part 38.1 to enter or exit the female part 40.1. According to one embodiment, the locking and unlocking system 42 comprises coupling elements 42.1, such as balls for example, that are movable radially with respect to the male part 38.1 between a protruding position, corresponding to the coupled state, and a retracted position, corresponding to the uncoupled state, and at least one radial housing secured to the female part 40.1 and configured to house the coupling elements 42.1 in the extended position.

The protection device 16 comprises at least one controller 44 configured to control the locked/unlocked state of the locking and unlocking system 42 of each fastening system 28. According to one configuration, the controller 44 is of pneumatic type. According to one embodiment, the protection device 16 comprises an automatically controllable controller 44 and possibly a manual controller.

Naturally, the invention is not limited to this embodiment for the fastening systems 28. Other solutions can be envisaged for coupling and uncoupling the protection device 16 and the printing device 12.

According to one embodiment, each fastening system 28 is connected to the rigid plate 30 by a flexible and deformable connection 46 allowing a slight deflection of the fastening system 28 with respect to the rigid plate 30.

According to one embodiment, the printing equipment 10 comprises a receptacle 48 which has a bottom 48.1 and a second peripheral edge 48.2 delimiting, with the bottom 48.1, a housing suitable for housing the frame 24. The first and second peripheral edges 30.1, 48.2 of the rigid plate 30 and of the receptacle 48 are substantially identical, so that the rigid plate 30 is substantially immobilized with respect to the receptacle 48 in a plane parallel to the bottom 48.1.

During operation, the robotic arm 12.2 moves the printhead 12.1 in a given frame of reference anchored to the base 12.3 of the printing device 12. Since the receptacle 48 is fixed with respect to the base 12.3, the position of the protection device 16 located in the receptacle 48 is known in the given frame of reference.

According to one configuration, at least one element from among the frame 24 and the receptacle 48 comprises at least one poka-yoke 50 allowing the frame 24 to be positioned in the receptacle 48 in a unique position.

According to one embodiment, the poka-yoke 50 comprises a notch 50.1 in the first peripheral edge 30.1 of the rigid plate 30 and a projection 50.2, having a shape complementary to that of the notch 50.1, secured to the second peripheral edge 48.2 of the receptacle 48.

Naturally, the invention is not limited to this embodiment for the poka-yoke 50.

According to one configuration, the printing equipment 10 comprises at least one first presence sensor configured to detect the presence of the rigid plate 30 in the receptacle 48 and to emit a first signal when the rigid plate 30 is positioned in the receptacle 48 and a second signal when the rigid plate 30 is not positioned in the receptacle 48. The printing equipment 10 may comprise at least one second presence sensor configured to detect the presence of the rigid plate 30 at the printing device 12.

A method for mounting a protection device 16 comprises a step of detecting the protection device 16 near to the printhead(s) 12.1 of the printing device 12 and/or in the receptacle 48.

If the protection device 16 is detected near to the printhead(s) 12.1 of the printing device 12 and is not detected in the receptacle 48, then the protection device 16 is considered to be correctly installed.

If the protection device 16 is not detected near to the printhead(s) 12.1 of the printing device 12 and is detected in the receptacle 48, then the mounting method comprises a step of activating the controller 44 in order to switch the locking and unlocking system 42 to the unlocked state, a step of moving the robotic arm 12.2 in order to insert the male part 38.1 of each fastening system 28 into the corresponding female part 40.1 and then, when each male part 38.1 of each fastening system 28 is positioned in the female part 40.1, a step of activating the controller 44 in order to switch the locking and unlocking system 42 to the locked state.

From then on, the printheads 12.1 are protected by the head protection covers 18.

When the printheads 12.1 need to be used, the head protection covers 18 are removed.

If the protection device 16 is detected near to the printhead(s) 12.1 of the printing device 12 and is not detected in the receptacle 48, then the method for withdrawing the protection device 16 comprises a step of moving the robotic arm 12.2 in order to position the protection device 16 in the receptacle 48 and then, as soon as the protection device 16 is detected in the receptacle 48, a step of activating the controller 44 in order to switch the locking and unlocking system 42 to the unlocked state in order to be able to uncouple the first and second parts 38, 40 of each fastening system 28.

If the protection device 16 is detected near to the printhead(s) 12.1 of the printing device 12 and is detected in the receptacle 48, then the method for withdrawing the protection device 16 comprises a step of activating the controller 44 in order to switch the locking and unlocking system 42 to the unlocked state in order to be able to uncouple the first and second parts 38, 40 of each fastening system 28.

From then on, the printheads 12.1 can be used to print.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A protection device comprising:
at least one head protection cover configured to cover at least one printhead of a printing device;
at least one frame comprising at least one rigid plate which has a first face oriented towards the printing device during operation and a second face opposite the first face, and at least one first opening passing through the at least one rigid plate and configured to house said at least one head protection cover;
for each head protection cover of the at least one head protection cover, at least one flexible connection system comprising first and second elastically deformable and diametrically opposing blades which connect said each head protection cover and the at least one rigid plate; and,
at least one automatic fastening system configured to connect the at least one rigid plate and the printing device.

2. The protective device according to claim 1, wherein the at least one automatic fastening system is connected to the at least one rigid plate by a flexible and deformable connection allowing a slight deflection of the at least one automatic fastening system with respect to the at least one rigid plate.

3. A printing equipment comprising:
at least one protection device according to claim 1.

4. The printing equipment according to claim 3, further comprising:
a receptacle which has a housing configured for at least partially housing the at least one protection device.

5. The printing equipment according to claim 4, wherein one of the at least one frame and the receptacle comprises at least one poka-yoke allowing the at least one frame to be positioned in the receptacle in a unique position.

6. The printing equipment according to claim 3, wherein each flexible connection system further comprises a first part secured to the printing device and a second part secured to the at least one rigid plate, the first and second parts configured to occupy a coupled state in which the first and second parts are secured to one another and an uncoupled state in which the first and second parts are detached from one another.

7. The printing equipment according to claim 6, wherein the first and second parts comprise a male part and a female part configured to allow self-centering of the first part with respect to the second part.

8. The printing equipment according to claim 7, wherein each flexible connection system further comprises:
at least one locking and unlocking system configured to occupy a locked state, in which the at least one locking and unlocking system keeps the male part in the female part, and an unlocked state, in which the at least one locking and unlocking system allows the male part to enter or exit the female part; and,
at least one controller configured to control the at least one locking and unlocking system of each fastening system.
